(19) United States
(12) Patent Application Publication
(10) Pub. No.: US 2025/0264215 A1
(43) Pub. Date: Aug. 21, 2025

(54) INFRARED BURNER AND GRILL

(71) Applicant: NINGBO AGSUN PRODUCTS,INC., CIXI (CN)

(72) Inventors: Jialong Yao, CIXI (CN); Luoda Ying, CIXI (CN); Xianghua Liu, CIXI (CN); Xuefei Mao, CIXI (CN)

(21) Appl. No.: 19/204,421

(22) Filed: May 9, 2025

(30) Foreign Application Priority Data
Mar. 17, 2025 (CN) 202520469073.9

(51) Int. Cl. F23D 14/14; A47J 37/07

(52) U.S. Cl. CPC F23D 14/14; A47J 37/0713

(57) ABSTRACT

An infrared burner and a grill are provided. The infrared burner includes a combustion tube and a cover body. A cover body is combined with the combustion tube through a closed opening, fire outlet holes communicate with a heating area, and flames sprayed from the fire outlet holes burn an infrared radiation plate to generate infrared radiation. By adopting the above solution, the flames from the fire outlet holes are concentrated in the heating area, so that the infrared radiation plate is heated to turn red to generate infrared radiation for heating.

### TECHNICAL FIELD

The present invention belongs to the field of burners, and in particular relates to an infrared burner and a grill.

### BACKGROUND

Traditional gas grills heat the surrounding air by gas combustion, and the heated surrounding air forms a hot airflow which flows upward through the food on the grilling net for grilling.

However, the above grilling method has a problem in that the hot airflow flows through the surface of the food for heating, and the inside of the food needs to be heated by heat conduction of the food itself after the surface of the food is heated, consequently the surface of the food is often burned while the inside is undercooked.

### SUMMARY

In view of the deficiencies of the prior art, it is an object of the present invention to provide an infrared burner and a grill in which flames from fire outlet holes are concentrated in a heating area, and the heating area gathers high temperature to heat an infrared radiation plate, so that the infrared radiation plate is heated to turn red to generate infrared radiation for heating.

In order to achieve the above object, the present invention provides the following technical solutions.

As a first aspect of the present invention, provided is an infrared burner which includes a combustion tube and a cover body; the combustion tube is provided with a plurality of fire outlet holes arranged in a length direction of the combustion tube; the cover body includes a heating area, a closed opening communicating with the heating area and an infrared radiation plate located above the heating area, and the infrared radiation plate is made of a metal material; and the cover body is combined with the combustion tube through the closed opening to cause the fire outlet holes to face the heating area and communicate with the heating area, and the fire outlet holes are configured to spray flames to burn the infrared radiation plate, so that the infrared radiation plate is burned red to generate infrared radiation.

As a second aspect of the present invention, provided is an infrared burner which includes a combustion tube, an infrared radiation plate and a heating area; the infrared radiation plate is located above the combustion tube and extends in a length direction of the combustion tube; the infrared radiation plate is arched upward, a width of the infrared radiation plate is s1, and an arching height of the infrared radiation plate is h, with s1>h or 2*h≤s1≤5*h; the infrared radiation plate is penetratingly provided with several first airflow channels; the heating area is formed between the combustion tube and the infrared radiation plate; and the infrared radiation plate is heated to cause an infrared radiation surface provided on the infrared radiation plate to be burned red to generate infrared radiation.

As a third aspect of the present invention, further provided is a grill which includes a grill body and a burner, where the burner is any one of the infrared burners described above, and the infrared burner is arranged on the grill body.

By adopting the above technical solutions, when the gas is introduced for combustion, the fire outlet holes arranged in a front-rear direction burn the gas at different positions in the front and rear of the heating area to generate flames; the flames burn and heat the infrared radiation plate, causing the infrared radiation plate to be burned red; the burned-red infrared radiation plate generates infrared radiation upward and heats the food through infrared radiation; and infrared rays can directly act on the food and have good penetrability to uniformly heat the inside and outside of the food, preventing the situation that the surface of the food is burned while the inside is undercooked.

### BRIEF DESCRIPTION OF THE DRAWINGS

In order to illustrate the technical schemes of the embodiments of the present invention or the prior art more clearly, the accompanying drawings to be used in the description of the embodiments or the prior art will be briefly introduced below. Obviously, the accompanying drawings in the following description are merely some rather than all embodiments of the present invention, and a person of ordinary skill in the art may still derive other drawings from these accompanying drawings without creative efforts.

FIG. 1 is an assembly diagram of a first embodiment of the present invention;

FIG. 2 is a cross-sectional view of the first embodiment of the present invention;

FIG. 3 is an exploded view of the first embodiment of the present invention;

FIG. 4 is a schematic diagram of a cover body according to the first embodiment of the present invention;

FIG. 5 is a schematic diagram of a combustion tube according to another embodiment of the present invention;

FIG. 6 is a schematic diagram of a combustion tube according to another embodiment of the present invention;

FIG. 7 is a schematic diagram of a combustion tube according to another embodiment of the present invention;

FIG. 8 is an assembly diagram of a cover body according to a second embodiment of the present invention;

FIG. 9 is an exploded view of the cover body according to the second embodiment of the present invention;

FIG. 10 is an assembly diagram of a cover body according to another embodiment of the present invention;

FIG. 11 is an assembly diagram of a cover body according to a third embodiment of the present invention;

FIG. 12 is an exploded view of the cover body according to the third embodiment of the present invention;

FIG. 13 is a top view of the cover body according to the third embodiment of the present invention;

FIG. 14 is an assembly diagram of a fourth embodiment of the present invention;

FIG. 15 is a cross-sectional view of the fourth embodiment of the present invention; and

FIG. 16 is an exploded view of the fourth embodiment of the present invention.

### DESCRIPTION OF REFERENCE NUMERALS

1. combustion tube;
11. first fire outlet hole; 12. second fire outlet hole; 13. third fire outlet hole; 14. fourth fire outlet hole;
111. intake end; 112. tube tail end; 141. first fire outlet portion; 142. second fire outlet portion;
2. cover body;
21. heating area; 22. infrared radiation surface; 23. infrared radiation plate; 24. closed enclosure plate; 25. second airflow channel; 26. first airflow channel; 27. closed opening;
231. first section; 232. second section; 241. closed end;
2321. intake section; 2322. tail end section;
3. grill body;
31. grill cavity; 32. support protrusion;
4. grilling net;
5. transparent plate;
61. first connection portion; 62. second connection portion.

### DESCRIPTION OF THE EMBODIMENTS

### First Embodiment

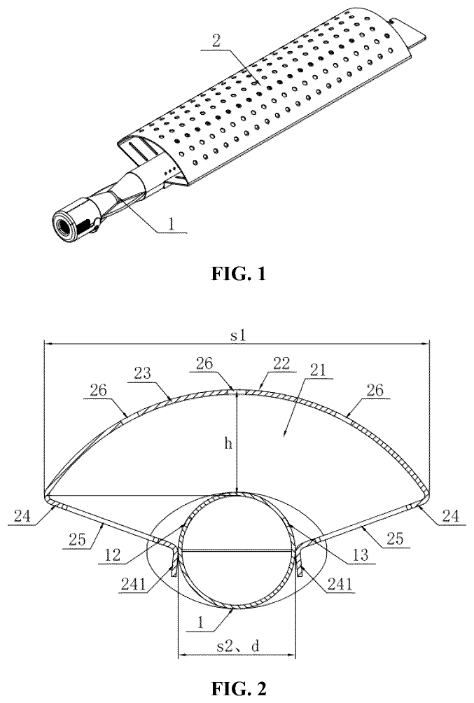

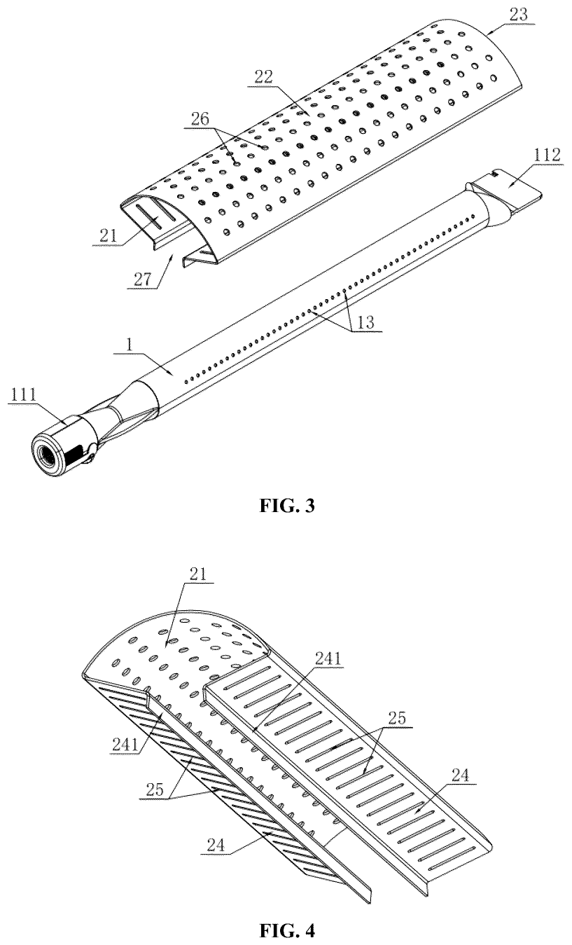

As shown in FIGS. 1-4, the present invention discloses an infrared burner including: a combustion tube 1 in the shape of a straight tube extending in a front-rear direction (i.e., a length direction), where a plurality of fire outlet holes are arranged on the combustion tube 1 in the front-rear direction, so that the plurality of fire outlet holes are distributed at different positions in the length direction of the combustion tube 1; and a cover body 2, where the cover body 2 is located above the combustion tube 1, a heating area 21 is provided in the cover body 2, the cover body 2 is composed of an infrared radiation plate 23 at the top and closed enclosure plates 24 on left and right sides, and a closed opening 27 is formed below the heating area 21, and a top portion of the infrared radiation plate 23 is provided with an infrared radiation surface 22.

When in use, the cover body 2 cooperates with the combustion tube 1, so that the combustion tube 1 closes the closed opening 27, and the fire outlet holes are located in the heating area 21, so that burning flames sprayed from the fire outlet holes burn in the heating area 21 to burn the infrared radiation plate 23 red, and the infrared radiation surface 22 arranged on the infrared radiation plate 23 is burned red and radiates infrared rays to heat the food.

Therefore, when the gas is introduced for combustion, the fire outlet holes arranged in the front-rear direction burn the gas at different positions in the front and rear of the heating area 21 to generate flames, and the flames burn in the heating area 21 and directly burn the infrared radiation plate 23 to transfer heat, so that the infrared radiation plate 23 is burned red. The burned-red infrared radiation surface 22 radiates infrared rays upward, and the food is heated by the infrared radiation. The infrared rays can directly act on the food and have good penetrability to uniformly heat the inside and outside of the food, preventing the situation that the surface of the food is burned while the inside is undercooked.

Here, the infrared radiation plate 23 is arched upward, a left-right width of the infrared radiation plate 23 is s1, and an arching height of the infrared radiation plate 23 is h, with s1>h. Preferably, 2*h≤s1≤5*h is satisfied. In addition, the infrared radiation plate 23 is penetratingly provided with several first airflow channels 26.

Therefore, the upward arched infrared radiation plate 23 cooperates with the first airflow channels 26 on the infrared radiation plate 23, so that the heat flow from the heating area 21 will flow along the infrared radiation plate 23 to the first airflow channels 26 after rising above a bottom portion of the infrared radiation plate 23 to transfer the heat to different positions of the infrared radiation plate 23 to uniformly heat the infrared radiation plate 23, and finally the heat flow exits the heating area 21 upward through the first airflow channels 26.

In addition, by limiting the left-right width of the infrared radiation plate 23 and the upward arching height of the infrared radiation plate 23, not only the infrared radiation plate 23 has a larger width to cover a larger infrared radiation area upward, but also the infrared radiation plate 23 has a smaller height difference, so that the heat flow can be easily diffused in a width direction below the infrared radiation plate 23, so that both sides of the infrared radiation surface 22 in the width direction can be guided to receive more heat to achieve more uniform heating as a whole.

In addition, due to the arrangement of the first airflow channels 26, the heat flow in the heating area 21 will flow out upward, so that the outgoing heat flow will flow upward to directly contact the food for grilling by heat conduction, and the grilling efficiency is improved under the dual effects of heat conduction of the heat flow and infrared radiation.

Specifically, in the present embodiment, s1=3.6*h is satisfied.

Here, the first airflow channels 26 in the present embodiment are uniformly arranged on the infrared radiation plate 23 in a rectangular array, and each of the first airflow channels 26 is in a circular hole shape.

Preferably, a cross section of the infrared radiation plate 23 in the present embodiment along the vertical front-rear direction is arranged in an arc shape to form a columnar arc surface and diffuse infrared radiation outward in an arc shape.

In other embodiments, the cross section of the infrared radiation plate 23 along the vertical front-rear direction may have a V-shape or a multi-section folded shape.

It should be noted that in order to prevent the heat in the heating area 21 from quickly flowing out of the first airflow channels 26 without sufficiently contacting the infrared radiation plate 23, so that the infrared radiation surface 22 can not be burned red, the following limitations are made: an area of the infrared radiation surface 22 is s2, and a sum of areas of the first airflow channels 26 projected onto the infrared radiation surface 22 is s3, with 0.05*s2≤s3<0.15*s2. Therefore, by setting a suitable ratio of the area of the infrared radiation surface 22 to the sum of the areas of the first airflow channels 26 projected onto the infrared radiation surface 22, the heat from the heating area 21 can be sufficiently transferred to the infrared radiation plate 23 to burn the infrared radiation surface 22 red.

Here, a width of the closed opening 27 is s4, and a diameter of the combustion tube 1 is d, preferably, s1>s4, d>s4, and s1>d. In the present embodiment, s1>3*s4 is satisfied, and d=s4.

Therefore, by setting the width of the closed opening 27 to a size adapted to the diameter of the combustion tube 1, the combustion tube 1 can effectively fit with the closed opening 27 to close the closed opening 27, and by providing the infrared radiation plate 23 with a larger width to increase the area of infrared radiation, the radiation is more uniform.

Here, the fire outlet holes in the present embodiment include a plurality of second fire outlet holes 12 and a plurality of third fire outlet holes 13 provided on left and right sides of a top portion of the combustion tube 1, and the second fire outlet holes 12 and the third fire outlet holes 13 are arranged in the length direction of the combustion tube 1.

Therefore, flames sprayed from the second fire outlet holes 12 directly heat a left half of the heating area 21, and flames sprayed from the third fire outlet holes 13 directly heat a right half of the heating area 21, so that the heat flow from the left half of the heating area easily flows to the left side of the infrared radiation plate 23, and the heat flow from the right half of the heating area easily flows to the right side of the infrared radiation plate 23, so that the edge can receive more heat and the entire infrared radiation surface 22 is burned red more uniformly.

Preferably, each of the second fire outlet holes 12 and each of the third fire outlet holes 13 extend in a radial direction of the combustion tube 1, so that the flames are sprayed in an inclined manner, and a spacing between the flames sprayed from the second fire outlet holes 12 and the third fire outlet holes 13 is increased, so that the heat is more uniform and the processing is more convenient.

In other embodiments, as shown in FIG. 5, a plurality of first fire outlet holes 11 provided on the top portion of the combustion tube 1 are used as the fire outlet holes, and each of the first fire outlet holes 11 is arranged in the length direction of the combustion tube 1, where the first fire outlet holes 11 are circular holes, so that the first fire outlet holes 11 spray flames upward. Therefore, the flames heat left and right middle portions of the heating area 21, and then spreads to the left and right sides by means of a heat flow to burn the infrared radiation surface 22 red.

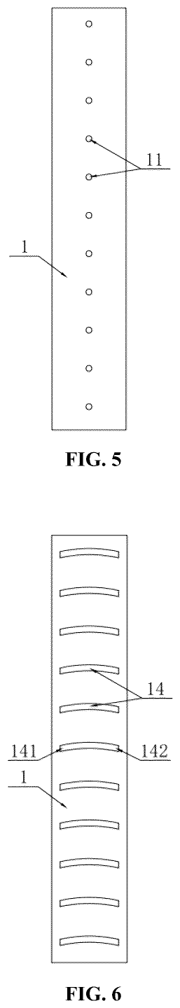

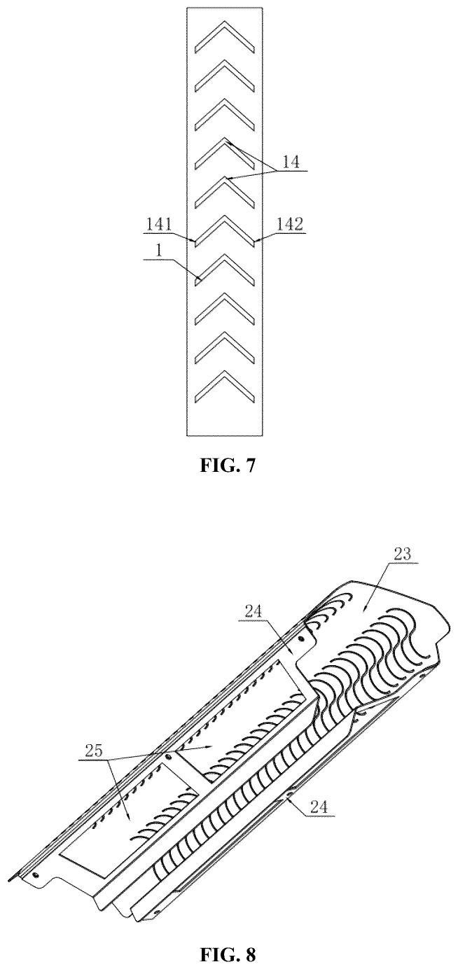

In other embodiments, as shown in FIGS. 6 and 7, a plurality of fourth fire outlet holes 14 provided on the top portion of the combustion tube 1 are used as the fire outlet holes, and each of the fourth fire outlet holes 14 is arranged in the length direction of the combustion tube 1, where the fourth fire outlet holes 14 in FIG. 6 are arc-shaped holes, and the fourth fire outlet holes 14 in FIG. 7 are V-shaped holes, so that the fourth fire outlet holes 14 located on the left and right sides of the top portion of the combustion tube 1 are respectively provided with a first fire outlet portion 141 and a second fire outlet portion 142 to spray flames upward. Therefore, the flames are sprayed from the fourth fire outlet holes 14 and cover in the left-right direction, the flames sprayed from the first fire outlet portions 141 directly heat the left half of the heating area 21, and the flames sprayed from the second fire outlet portions 142 directly heat the right half of the heating area 21, so that the heat flow from the left half of the heating area easily flows to the left side of the infrared radiation plate 23, and the heat flow from the right half of the heating area easily flows to the right side of the infrared radiation plate 23, so that the edge can receive more heat and the entire infrared radiation surface 22 is burned red more uniformly.

Here, due to the arrangement of the closed enclosure plates 24 on the left and right sides of the heating area 21, both sides of the heating area 21 are covered by the closed enclosure plates 24, so that less heat in the heating area 21 is lost through the left and right sides of the infrared radiation plate 23, so that the heat is more effectively conducted to the infrared radiation plate 23 to burn the infrared radiation surface 22 red.

In addition, the closed enclosure plates 24 are penetratingly provided with second airflow channels 25, so that when the combustion tube 1 is burning the gas, external air can enter the heating area 21 through the second airflow channels 25 to supplement oxygen, thereby ensuring complete combustion of the gas.

Preferably, the closed enclosure plates 24 in the present embodiment are integrally formed on the infrared radiation plate 23 and combined to form the cover body 2, where the cover body 2 is a metal piece.

Here, the closed enclosure plates 24 are each provided with a closed end 241 abutting against an outer peripheral wall of the combustion tube 1, and the closed end 241 is arranged at a position lower than the fire outlet holes, so that the closed opening 27 is more effectively closed by means of abutment between the closed end 241 and the outer peripheral wall of the combustion tube 1.

Here, in the present embodiment, the cover body 2 is welded to the combustion tube 1 at the closed end 241 to form an undetachable fixed connection state. In other embodiments, a detachable fixed connection state of the cover body 2 and the combustion tube 1 can be realized by snap connection or the like.

Preferably, the closed enclosure plates 24 are in an inclined plate shape, one side of each of the closed enclosure plates 24 inclined upward is connected with one side of the infrared radiation plate 23, and the closed end 241 is arranged on the side of each of the closed enclosure plates 24 inclined downward.

Therefore, the above structural combination makes the cover body 2 and the heating area 21 similar to a fan-shaped structure as a whole, and the fan-shaped heating area 21 has a smaller volume and a more regular overall structure than a square structure, and the closed enclosure plates 24 have the effect of guiding the heat flow and the flame upward to heat the infrared radiation plate 23 more effectively, which improves the conversion efficiency of converting heat energy of the flames into radiation energy of the infrared radiation plate 23.

Specifically, the closed ends 241 and the closed enclosure plates 24 have a bent structure, so that an arc-shaped transition angle is formed therebetween, and a smaller extrusion stress between the closed ends and the closed enclosure plates can be realized by abutting the transition angle against an outer wall of the combustion tube 1.

Preferably, a spacing between the two closed ends 241 extends downward and gradually increases, so that when the cover body 2 and the combustion tube 1 are aligned and assembled, they are guided by the flared closed ends 241 to improve the ease and smoothness of assembly. In other embodiments, the closed enclosure plates 24 can also be omitted.

### Second Embodiment

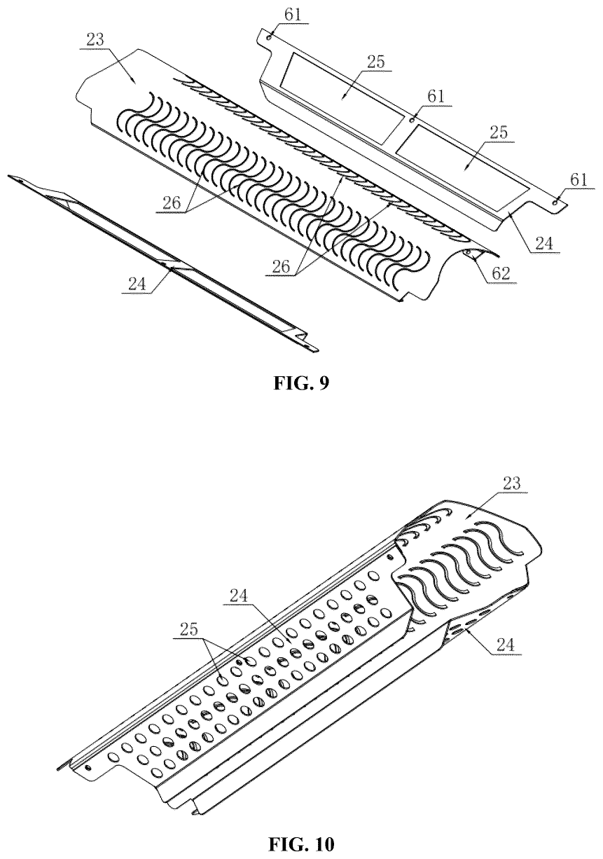

As shown in FIGS. 8 and 9, the present invention discloses an infrared burner which has a main structure the same as the first embodiment, except that the first airflow channels 26 are provided in left and right rows on both sides of the top portion of the infrared radiation plate 23, and the first airflow channels 26 in each row are arranged at intervals in the front-rear direction. In addition, each of the first airflow channels 26 is in an S shape.

In addition, the present embodiment also differs from the first embodiment in the shape and size of the second airflow channels 25, and larger square second airflow channels 25 are provided, so that the left and right sides of the heating area 21 can better communicate with the outside.

Therefore, when there is excess heat in the heating area 21 (for example, when the configured gas pipe burns the gas with a greater flame intensity), the heat can overflow the heating area 21 through the second airflow channels 25, and the remaining heat can effectively supply heat to burn the infrared radiation surface 22 red, which has the effect of preventing non-uniform burning red of the infrared radiation surface 22 caused by the excess heat.

Correspondingly, the closed enclosure plates 24 and the infrared radiation plate 23 are detachably connected, and in the present embodiment, a plurality of first connection portions 61 are provided on an upper side of each of the closed enclosure plates 24. Correspondingly, second connection portions 62 are provided on the left and right sides of the infrared radiation plate 23 respectively. The first connection portions 61 and the second connection portions 62 are aligned to realize snap connection or bolt-nut connection.

Therefore, by replacing different closed enclosure plates 24, the distribution, shape and size of the second airflow channels on different closed enclosure plates 24 can be adapted to different sizes of heating areas 21 and combustion tubes 1.

As shown in FIG. 8, the second airflow channels 25 formed by the cover body 2 arranged on the gas pipe are larger, so that the heat from the heating region 21 is easily dissipated, while the circular second airflow channels 25 arranged in a matrix formed by the cover body 2 arranged on the gas pipe shown in FIG. 10 is smaller, so that less heat is dissipated from the heating region 21.

### Third Embodiment

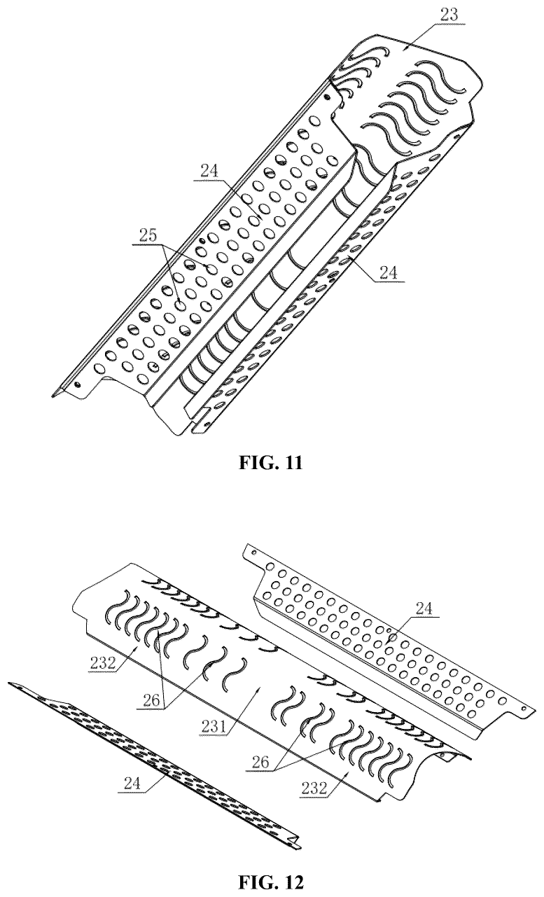

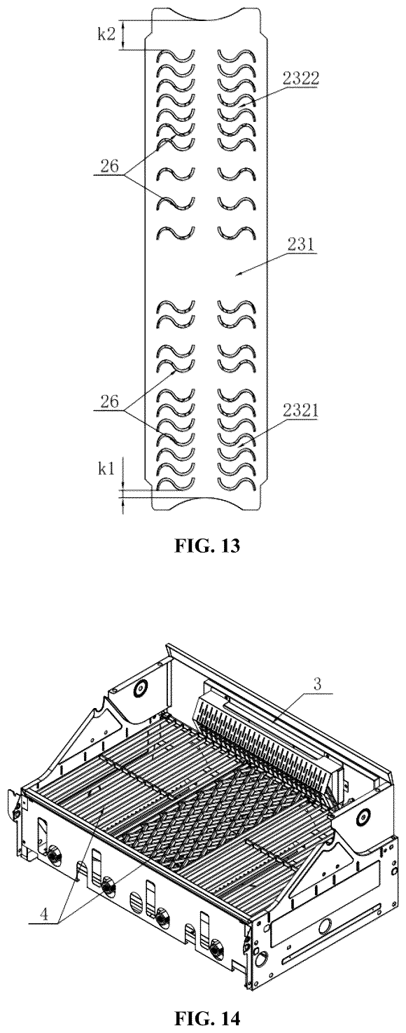

As shown in FIGS. 11 to 13, the present invention discloses an infrared burner which has a main structure the same as the second embodiment, except that the first airflow channels 26 are arranged in a different way. Specifically, the infrared radiation plate 23 includes a first section 231 in a middle portion and second sections 232 located at front and rear ends of the first section 231. An average spacing between adjacent first airflow channels 26 on the first section 231 is larger than an average spacing between adjacent first airflow channels 26 on the second sections 232. In other words, the first airflow channels 26 on the first section 231 are sparse, and the first airflow channels 26 on the second section 232 are dense.

Therefore, the heat flow formed by the combustion in the middle of the gas pipe will flow forward or backward to the second section 232 due to the sparse first airflow channels 26 on the first section 231, thereby bringing the heat to the second sections 232 to heat the second sections 232, so that the heat energy is more diffused to an end portion, improving uniformity of the infrared radiation surface 22 being burned red, and resulting in uniform radiation in the length direction.

More preferably, the combustion tube 1 includes an intake end 111 at the front end and a tube tail end 112 at the rear end, and the second sections 232 each include an intake section 2321 corresponding to the intake end 111 and a tail end section 2322 corresponding to the tube tail end 112. A spacing between an end portion of the intake section 2321 away from the first section 231 and the closest first airflow channel 26 is k1, and a spacing between an end portion of the tail end section 2322 away from the first section 231 and the closest first airflow channel 26 is k2, with k1<k2.

It should be noted that since a mixture of the gas introduced from a front end of the gas pipe and air is not heated, less energy is provided for heating the heating area 21 after combustion, so that the heating area 21 close to the intake end 111 has a lower temperature, and the mixture of the gas from a rear end and air is heated when transmitted through the gas pipe, so that more energy is provided for heating the heating area 21 after combustion, so that the heating area 21 close to the tube tail end 112 has a higher temperature. In order to achieve more uniform temperature in front of and behind the infrared radiation surface, the first airflow channels 26 at the intake section 2321 are arranged closer to the end portion, so that the heat flow in the heating area 21 can be more guided to the end portion of the intake section 2321, thus improving the heating of the end portion of the intake section 2321 and optimizing the uniformity.

### Fourth Embodiment

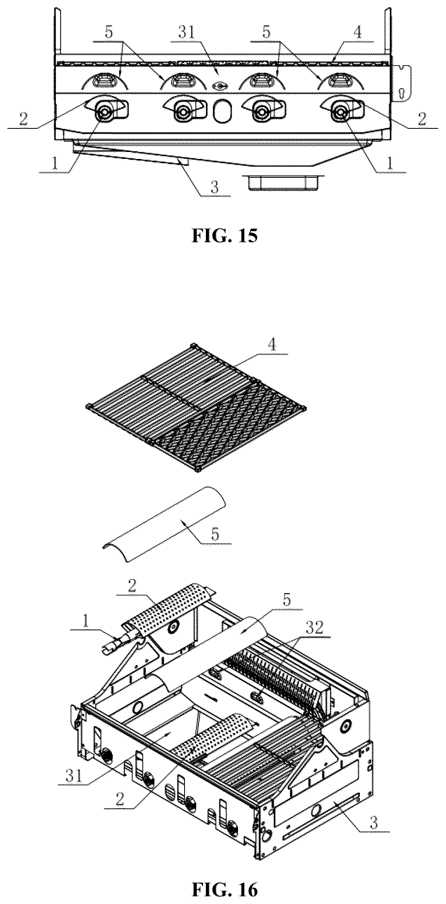

As shown in FIGS. 14 to 16, the present invention discloses a grill which includes a grill body 3 and the infrared burner according to any of the first embodiment to the third embodiment, where a grill cavity 31 with an upper opening is provided inside the grill body 3, and the grill body 3 is provided with a grilling net 4 above the grill cavity 31; and the infrared burner is arranged in the grill cavity 31, and the combustion tube 1 is connected to the gas so that the combustion tube 1 can burn and generate flames at each fire outlet hole.

Therefore, the food to be grilled can be placed on the grilling net 4, and the infrared radiation generated by the infrared radiation surface 22 burned red by the combustion of the infrared burner acts on the food for grilling.

Here, the rear end of the combustion tube 1 is mounted by being inserted into a side wall of the grill body 3.

In addition, a transparent plate 5 is also provided in the grill cavity 31. The transparent plate 5 is in an arc structure, and a length direction of the transparent plate 5 is in the front-rear direction. Correspondingly, the grill body 3 is provided with support protrusions 32 on both front and rear sides of the transparent plate 5, and front and rear ends of the transparent plate 5 are supported by the support protrusions 32 to be fixed relative to each other. In a fixed state. the transparent plate 5 is located above the cover body 2 to cover the infrared radiation plate 23.

Therefore, the transparent plate 5 made of a transparent material allows the infrared radiation generated by the infrared radiation surface 22 below to be radiated upward through the transparent plate 5, and garbage falling from above is shielded by the transparent plate 5 and does not fall onto the infrared radiation plate 23, in order to prevent the garbage from affecting the radiation effect of the infrared radiation surface 22 and prevent the garbage from blocking the first airflow channels 26.

Here, the transparent plate 5 may be a glass plate or other high temperature resistant polymer plates.

### Fifth Embodiment

A grill has a main structure the same as the fourth embodiment, except that the cover body 2 and the combustion tube 1 are non-fixedly connected only in contact, or they are not in contact, which can be realized in a way that the closed end 241 is only close to the combustion tube 1, that is, there is no fixed connection such as welding or snap connection therebetween.

Correspondingly, the cover body 2 and the combustion tube 1 are directly fixedly mounted on the grill, so that the cover body 2 and the combustion tube 1 are maintained at a stable relative position, and the state shown in any of the first embodiment to the third embodiments is formed at the stable relative position.

The previous description of the disclosed embodiments is provided to enable any person skilled in the art to make or use the present invention. Various modifications to these embodiments will be readily apparent to those skilled in the art, and the generic principles defined herein may be implemented in other embodiments without departing from the spirit or scope of the present invention. Thus, the present invention is not intended to be limited to the embodiments shown herein but is to be accorded the widest scope consistent with the principles and novel features disclosed herein.

What is claimed is:

1. An infrared burner, comprising:
a combustion tube provided with a plurality of fire outlet holes arranged in a length direction of the combustion tube; and
a cover body comprising a heating area, a closed opening communicating with the heating area and an infrared radiation plate located above the heating area, the infrared radiation plate being made of a metal material; and
wherein the cover body is combined with the combustion tube through the closed opening, the fire outlet holes face the heating area and communicate with the heating area, and the fire outlet holes are configured to spray flames to burn the infrared radiation plate, so that the infrared radiation plate is burned red to generate infrared radiation.

2. The infrared burner according to claim 1, wherein the cover body comprises two closed enclosure plates provided on both sides of the infrared radiation plate, the closed enclosure plates are each provided with a closed end abutting against an outer peripheral wall of the combustion tube, and the closed end is arranged at a position lower than the fire outlet holes.

3. The infrared burner according to claim 2, wherein the closed enclosure plates are in an inclined plate shape, one side of each of the closed enclosure plates is connected with one side of the infrared radiation plate, and the closed end is arranged on the opposite side of each of the closed enclosure plates.

4. The infrared burner according to claim 2, wherein the closed enclosure plates are detachably arranged on the infrared radiation plate.

5. The infrared burner according to claim 2, wherein the closed enclosure plates are each provided with a plurality of second airflow channels which are arranged in a length direction of the closed enclosure plates.

6. The infrared burner according to claim 4, wherein the infrared radiation plate is provided with a plurality of first airflow channels which are arranged in a length direction of the infrared radiation plate.

7. The infrared burner according to claim 1, wherein the fire outlet holes comprise a plurality of first fire outlet holes provided on a top portion of the combustion tube, the plurality of first fire outlet holes are arranged in the length direction of the combustion tube, and the first fire outlet holes spray flames upward.

8. The infrared burner according to claim 7, wherein the fire outlet holes comprise a plurality of second fire outlet holes and a plurality of third fire outlet holes provided on both sides of the top portion of the combustion tube, and the plurality of second fire outlet holes and the plurality of third fire outlet holes are arranged in the length direction of the combustion tube.

9. The infrared burner according to claim 8, wherein the fire outlet holes comprise a plurality of fourth fire outlet holes provided on the top portion of the combustion tube, the plurality of fourth fire outlet holes are arranged in the length direction of the combustion tube, and the plurality of fourth fire outlet holes are respectively provided with a first fire outlet portion and a second fire outlet portion on both sides of the top portion of the combustion tube.

10. An infrared burner, comprising:
a combustion tube;
an infrared radiation plate provided above the combustion tube and extending in a length direction of the combustion tube, the infrared radiation plate being arched upward, a width of the infrared radiation plate being s1, and an arching height of the infrared radiation plate being h, with s1>h or 2*h≤s1≤5*h, and the infrared radiation plate being penetratingly provided with several first airflow channels; and
a heating area formed between the combustion tube and the infrared radiation plate; and
wherein the infrared radiation plate is heated to cause an infrared radiation surface provided on the infrared radiation plate to be burned red to generate infrared radiation.

11. The infrared burner according to claim 10, wherein the infrared radiation plate comprises a first section and second sections located at both ends of the first section, and a spacing between two adjacent first airflow channels arranged on the first section is greater than a spacing between two adjacent first airflow channels arranged on the second sections.

12. The infrared burner according to claim 11, wherein the combustion tube comprises an intake end and a tube tail end, and the second sections each comprise an intake section corresponding to the intake end and a tail end section corresponding to the tube tail end.

13. The infrared burner according to claim 12, wherein a spacing between an end portion of the intake section away from the first section and the closest first airflow channel is k1, and a spacing between an end portion of the tail end section away from the first section and the closest first airflow channel is k2, with k1<k2.

14. The infrared burner according to claim 10, wherein a cross section of the infrared radiation plate along the length direction perpendicular to the infrared radiation plate is arranged in an arc shape.

15. The infrared burner according to claim 10, wherein the first airflow channels are each in a circular or S shape.

16. The infrared burner according to claim 10, wherein an area of the infrared radiation surface is s2, and a sum of areas of the first airflow channels projected onto the infrared radiation surface is s3, with 0.05*s2≤s3≤0.15*s2.

17. A grill, comprising:
a grill body; and
the infrared burner according to claim 10; and
wherein the infrared burner is arranged on the grill body.

18. The grill according to claim 17, wherein a transparent plate is provided in a grill cavity of the grill body, and the transparent plate is arranged above an infrared radiation plate of the infrared burner.

19. The grill according to claim 17, wherein the infrared radiation plate is mounted in contact with the combustion tube via two closed enclosure plates.

20. The grill according to claim 17, wherein a cover body and the combustion tube of the infrared burner are respectively mounted on the grill body, and the cover body is not in contact with the combustion tube.
